(19) United States
(12) Patent Application Publication
(10) Pub. No.: US 2011/0037621 A1
(43) Pub. Date: Feb. 17, 2011

(54) INFORMATION DISPLAY APPARATUS, POSITION CALCULATION APPARATUS, DISPLAY CONTROL METHOD, POSITION CALCULATION METHOD, DISPLAY CONTROL PROGRAM, POSITION CALCULATION PROGRAM, AND RECORDING MEDIUM

(75) Inventors: Toshiki Fujiwara, Saitama (JP); Seiji Goto, Saitama (JP)

Correspondence Address: YOUNG & THOMPSON, 209 Madison Street, Suite 500, Alexandria, VA, 22314, US

(73) Assignee: PIONEER CORPORATION, Kawasaki-shi, Kanagawa (JP)

(21) Appl. No.: 12/937,574

(22) PCT Filed: Apr. 14, 2008
(86) PCT No.: PCT/JP08/57304

§ 371 Date: Oct. 13, 2010

(51) Int. Cl. G08G 1/123; G01C 21/00

(52) U.S. Cl. 340/995.27; 701/207

(57) ABSTRACT

A data display device includes: a position obtaining unit obtaining current position data of a mobile object; a direction obtaining unit obtaining traveling direction data of the mobile object; a display control unit causing a display unit to display a current position and a traveling direction of the mobile object based on the current position data and the traveling direction data of the mobile object; and a determining unit determining that the mobile object has entered or exited a parking lot based on the current position data of the mobile object. The display control unit causes the display unit to display the mobile object so the current position of the mobile object is not changed and only the traveling direction of the mobile object is changed, from a determination that the mobile object has entered the parking lot until a determination that the mobile object has exited the parking lot.

### TECHNICAL FIELD

The present invention relates to a data display device, a position calculation device, a display control method, a position calculation method, a display control program, a position calculation program, and a recording medium for displaying or calculating the current position of a mobile object.

### BACKGROUND ART

Conventionally, a navigation device mounted on a mobile object such as a vehicle calculates the current position of the vehicle based on satellite navigation and inertial navigation, and sets the current position on road data. With satellite navigation, signals sent from global-positioning-system (GPS) satellites are received by a GPS receiver, and the geometric position of the GPS receiver with respect to each GPS satellite is calculated to compute the current position of the vehicle on the earth. With inertial navigation, displacement and traveling direction of the vehicle are multiplied by an inertial sensor such as a velocity sensor and a direction sensor, to compute the current position of the vehicle.

Recently, upon detection of GPS measurement inability information by the GPS receiver, a determination of indoor parking lot is started in which the current position of the vehicle is determined, based on the output of the direction sensor, to be in an indoor parking lot when the number of times that the vehicle has circled tightly in the same direction is detected to be a given number or more. The current position of the vehicle is set in the indoor parking lot (not on a road around the indoor parking lot) based on the output of the inertial sensor (see, for example, Patent Document 1 below).

Patent Document 1: Japanese Patent Application Laid-Open Publication No. 2000-310542

### DISCLOSURE OF INVENTION

### Problem to be Solved by the Invention

However, when the parking spaces of the indoor parking lot are divided into several floors, the vehicle circles when going up and down a slope that passes through the floors. Thus, according to the conventional technology described above, the effect of the gravity due to the slope causes the displacement calculated by the inertial sensor to be greater than the actual displacement, thereby causing an error in the current position of the vehicle. When the vehicle exits the indoor parking lot, the error in the current position in the indoor parking lot causes the current position to be set on a road where the vehicle is not actually positioned.

### Means for Solving Problem

To solve the problems above and achieve an object, a data display device according to claim 1 includes: a position obtaining unit that obtains current position data of a mobile object; a direction obtaining unit that obtains traveling direction data of the mobile object; a display control unit that causes a display unit to display a current position and a traveling direction of the mobile object based on the current position data and the traveling direction data of the mobile object; and a determining unit that determines that the mobile object has entered or exited a parking lot based on the current position data of the mobile object. The display control unit causes the display unit to display the mobile object such that the current position of the mobile object is not changed and only the traveling direction of the mobile object is changed, from a determination that the mobile object has entered the parking lot until a determination that the mobile object has exited the parking lot.

A position calculation device according to claim 4 includes: a position obtaining unit that obtains current position data of a mobile object; a direction obtaining unit that obtains traveling direction data of the mobile object; a calculating unit that calculates a current position and a traveling direction of the mobile object based on the current position data and the traveling direction data of the mobile object; and a determining unit that determines that the mobile object has entered or exited a parking lot based on the current position data of the mobile object. The calculating unit calculates only the traveling direction of the mobile object without calculating the current position of the mobile object, from a determination that the mobile object has entered the parking lot until a determination that the mobile object has exited the parking lot.

A display control method according to claim 5 is for a data display device that includes a position obtaining unit and a direction obtaining unit that obtain current position data and traveling direction data of a mobile object, respectively, and displays a current position and a traveling direction of the mobile object based on the current position data and the traveling direction data of the mobile object. The display control method includes: determining that the mobile object has entered or exited a parking lot based on the current position data of the mobile object; and causing the data display device to display the mobile object such that the current position of the mobile object is not changed and only the traveling direction of the mobile object is changed, from a determination that the mobile object has entered the parking lot until a determination that the mobile object has exited the parking lot.

A position calculation method according to claim 6 is for a position calculation device that includes a position obtaining unit and a direction obtaining unit that obtain current position data and traveling direction data of a mobile object, respectively, and calculates a current position and a traveling direction of the mobile object based on the current position data and the traveling direction data of the mobile object. The position calculation method includes: determining that the mobile object has entered or exited a parking lot based on the current position data of the mobile object; and calculating only the traveling direction of the mobile object without calculating the current position of the mobile object, from a determination that the mobile object has entered the parking lot until a determination that the mobile object has exited the parking lot.

A display control program according to claim 7 causes a computer to execute the display control method according to claim 5.

A position calculation program according to claim 8 causes a computer to execute the position calculation method according to claim 6.

A recording medium according to claim 9 stores therein the display control program according to claim 7 or the position calculation program according to claim 8 so as to be read by a computer.

### BRIEF DESCRIPTION OF DRAWINGS

FIG. 1 is a block diagram of a functional configuration of a data display device according to a first embodiment;

FIG. 2 is a flowchart of a procedure of display control process performed by the data display device;

FIG. 3 is a block diagram of a functional configuration of a position calculation device according to a second embodiment;

FIG. 4 is a flowchart of a procedure of position calculation process performed by the position calculation device;

FIG. 5 is a block diagram of a hardware configuration of a navigation device according to an example;

FIG. 6 is a flowchart indicating contents of a process performed by the navigation device;

FIG. 7 is a diagram of an actual trace of a vehicle; and

FIG. 8 is a diagram for explaining the difference in display of a current position mark of the vehicle between a conventional example and a present example.

### EXPLANATIONS OF LETTERS OR NUMERALS

100 data display device
101 display unit
102 position obtaining unit
103 direction obtaining unit
104 determining unit
105 display control unit

### BEST MODE(S) FOR CARRYING OUT THE INVENTION

Preferred embodiments of a data display device, a position calculation device, a display control method, a position calculation method, a display control program, a position calculation program, and a recording medium according to the present invention will be described with reference to the accompanying drawings.

### First Embodiment

### (Functional Configuration of Data Display Device)

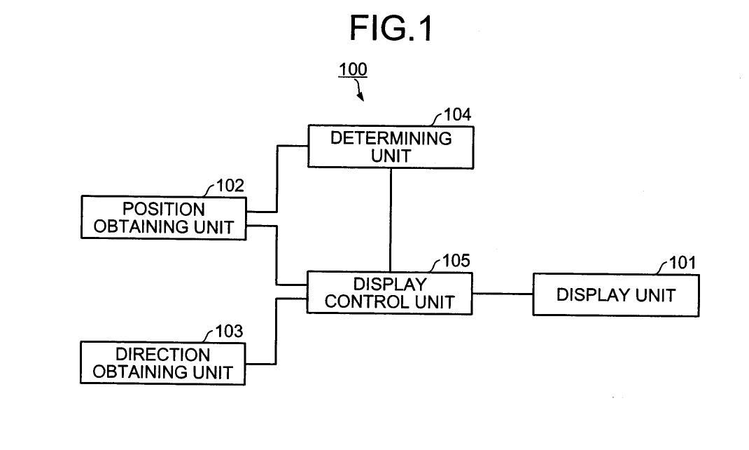

A functional configuration of a data display device 100 according to a first embodiment is described first. FIG. 1 is a block diagram of a functional configuration of the data display device according to the first embodiment.

As depicted in FIG. 1, the data display device 100 includes a display unit 101, a position obtaining unit 102, a direction obtaining unit 103, a determining unit 104, and a display control unit 105. The display unit 101 includes a display screen that displays map data stored in a storing unit (not shown). The map data includes road network data constituted by nodes and links, and image data depicted based on features concerning facilities, roads, and other land features (mountains, rivers, lands). The map data may further include character data, data of facilities such as names and addresses, and images of roads and facilities, etc.

The position obtaining unit 102 obtains current position data of a mobile object by, for example, receiving signals from GPS satellites. The position obtaining unit 102 may obtain the current position data by calculating the current position of the mobile object based on data obtained by receiving the signals from the GPS satellites and data concerning movement of the mobile object obtained by a velocity sensor, an acceleration sensor, and a gyro sensor that detect the velocity, acceleration, and traveling direction of the mobile object, respectively.

The direction obtaining unit 103 obtains traveling direction data of the mobile object based on, for example, output data from a direction sensor that detects change in the traveling direction of the mobile object.

The determining unit 104 determines whether the mobile object has entered/exited a parking lot based on the current position data of the mobile object obtained by the position obtaining unit 102. The determining unit 104 may also determine whether the mobile object is positioned on a road. The determining unit 104 determines whether the mobile object has entered/exited the parking lot based on, for example, the reception intensity of the signals from the GPS satellites obtained by the position obtaining unit 102 and changes in the evaluation of each GPS satellite and in the number of available GPS satellites. For example, the determining unit 104 may determine the mobile object has entered a parking lot when the mobile object is not positioned on a road and the reception intensity from the GPS satellites or the number of available GPS satellites is below a given value. The determining unit 104 may determine the mobile object has exited the parking lot when the reception intensity from the GPS satellites or the number of available GPS satellites exceeds a given value.

Alternatively, the determining unit 104 determines whether the mobile object has entered a parking lot based on, for example, map data and/or history data stored in a storing unit (not shown). The map data include position data of parking lots, and the history data include position data of parking lots where the vehicle entered in the past. The determining unit 104 determines the mobile object has entered a parking lot when the current position of the mobile object is determined, based on the position data, to be the same as the parking lot.

The determining unit 104 may determine the mobile object has exited a parking lot when the traveling direction of the mobile object is substantially constant and the displacement of the mobile object reaches a given value. Alternatively, the determining unit 104 may determine the mobile object has exited a parking lot when the speed of the mobile object reaches a given value (for example, 35 km/h or more), or when the altitude of the mobile object returns to the altitude when the mobile object was determined to enter the parking lot (the altitude is stored in the storing unit).

Together with the entry/exit of the mobile object to/from the parking lot, the determining unit 104 may also determine the type of the parking lot based on, for example, the reception intensity of the signals from the GPS satellites obtained by the position obtaining unit 102 and changes in the evaluation of each GPS satellite and in the number of available GPS satellites.

The display control unit 105 causes the display unit 101 to display the current position and the traveling direction of the mobile object based on the current position data and the traveling direction data of the mobile object. The display control unit 105 causes the display unit 101 to display the mobile object such that the current position of the mobile object is not changed and only the traveling direction thereof is changed, from the determination by the determining unit 104 that the mobile object has entered the parking lot until the determination that the mobile object has exited the parking lot.

When the type of the parking lot is determined by the determining unit 104, the display control unit 105 may cause the display unit 101 to display the mobile object such that the current position of the mobile object is not changed and only the traveling direction thereof is changed, from the determination that the mobile object has entered the indoor parking lot until the determination that the mobile object has exited the indoor parking lot.

When the map data is displayed on the display unit 101, the display control unit 105 causes the display unit 101 to display a mark on the map. The mark is disposed on the current position of the mobile object and oriented to the traveling direction of the mobile object, and displayed such that the position thereof is not changed and only the orientation thereof is changed, from the determination by the determining unit 104 that the mobile object has entered the parking lot until the determination that the mobile object has exited the parking lot.

### (Procedure of Display Control Process Performed by Data Display Device)

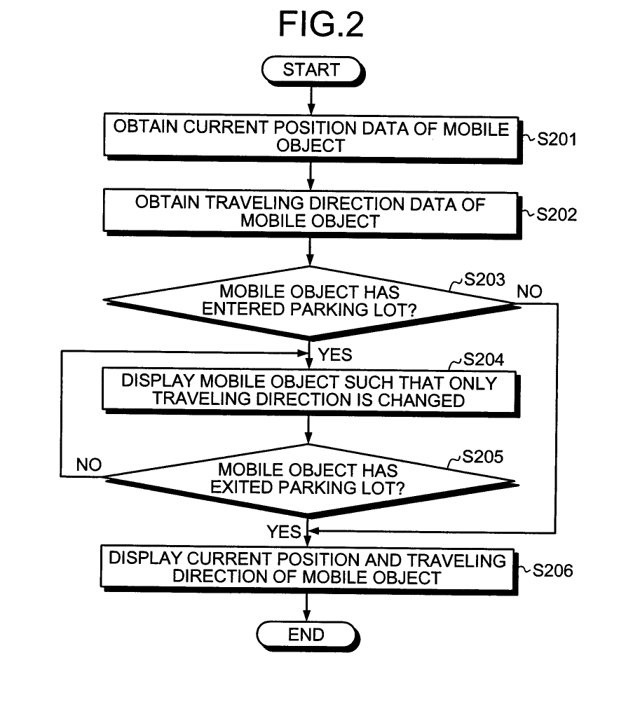

A procedure of display control process performed by the data display device 100 is described next. FIG. 2 is a flowchart of the procedure of display control process performed by the data display device. As depicted in the flowchart of FIG. 2, the current position data of the mobile object are obtained by the position obtaining unit 102 (step S201). The traveling direction data of the mobile object are obtained by the direction obtaining unit 103 (step S202). Steps S201 and S202 are continuously executed during execution of steps S203 to S206 described later.

Whether the mobile object has entered a parking lot is determined by the determining unit 104 based on the current position data of the mobile object obtained at step S201 (step S203). When it is determined at step S203 that the mobile object has entered the parking lot (step S203: YES), the display unit 101 is caused by the display control unit 105 to display the mobile object such that the current position of the mobile object is not changed and only the traveling direction thereof is changed (step S204).

Whether the mobile object has exited the parking lot is determined by the determining unit 104 based on the current position data of the mobile object obtained at step S201 (step S205). When it is not determined at step S205 that the mobile object has exited the parking lot (step S205: NO), the process returns to step S204 and subsequent steps are executed repeatedly.

When it is determined at step S205 that the mobile object has exited the parking lot (step S205: YES), the display unit 101 is caused by the display control unit 105 to display the current position and the traveling direction of the mobile object based on the current position data and the traveling direction data of the mobile object obtained at steps S201 and S202, respectively (step S206), thereby ending the sequence of processes.

On the other hand, when it is not determined at step S203 that the mobile object has entered the parking lot (step S203: NO), the process proceeds to step S206 and the display unit 101 is caused by the display control unit 105 to display the current position and the traveling direction of the mobile object based on the current position data and the traveling direction data of the mobile object obtained at steps S201 and S202, respectively, thereby ending the sequence of processes.

In the flowchart of FIG. 2, the type of the parking lot may be also determined at step S203 together with the entry of the mobile object to the parking lot. The process proceeds to step S204 when it is determined that the mobile object has entered an indoor parking lot, while the process proceeds to step S206 when it is determined at step S203 that the mobile object has entered a parking lot other than the indoor parking lot.

When the position obtaining unit 102 obtains a value multiplied in hybrid measurement as the current position data of the mobile object, the process may proceed to step S204 when the mobile object has entered a roof parking lot at step S203. This is because an error included in a relative displacement output from the various sensors 516, which is multiplied in hybrid measurement by the result of measurement obtained from GPS, increases as the mobile object moves and circles upon entry to/exit from the roof parking lot.

In the flowchart of FIG. 2, when the mark disposed on the current position of the mobile object and oriented to the traveling direction of the mobile object is displayed on the map data, the display unit 101 is caused by the display control unit 105 to display the mark on the map at step S204 such that the position of the mark is not changed and only the orientation thereof is changed. The display unit 101 is also caused by the display control unit 105 to display the mark on the map at step S206 such that the position and the direction of the mark are both changed.

As described above, the data display device 100 according to the first embodiment can cause the display unit 101 to display, by the display control unit 105 that causes the display unit 101 to display the current position and the traveling direction of the mobile object, the mobile object such that the current position of the mobile object is not changed and only the traveling direction thereof is changed, from the determination that the mobile object has entered the parking lot until the determination that the mobile object has exited the parking lot. Thus, even when an accurate position and/or direction cannot be obtained due to weak signals from GPS satellites, the error in the current position of the mobile object is limited to the size of the parking lot, thereby reducing the error in the current position of the mobile object.

The data display device 100 according to the first embodiment can cause the display unit 101 to display, by the display control unit 105, the mobile object such that the current position of the mobile object is not changed and only the traveling direction thereof is changed, from the determination that the mobile object has entered the indoor parking lot until the determination that the mobile object has exited the indoor parking lot. Thus, the position and the direction are changed for a roof parking lot where signals from GPS satellites are strong, while only the direction is changed for an indoor parking lot where signals from GPS satellites are weak. Thus, the position and the direction are changed even when the mobile object is positioned in a parking lot as long as an accurate position and/or direction are obtained, thereby further reducing the error in the current position of the mobile object.

The data display device 100 according to the first embodiment causes, by the display control unit 105, the display unit 101 to display on a map a mark disposed on the current position of the mobile object and oriented to the traveling direction of the mobile object. The data display device 100 can cause, by the display control unit 105, a display means to display the mark on the map such that the position of the mark is not changed and only the orientation thereof is changed, from the determination that the mobile object has entered the parking lot until the determination that the mobile object has exited the parking lot. Thus, even when an accurate position and/or direction cannot be obtained due to weak signals from GPS satellites, the error in the position of the mark is limited to the size of the parking lot, thereby reducing an error in map matching after the exit from the parking lot.

### Second Embodiment

### (Functional Configuration of Data Display Device)

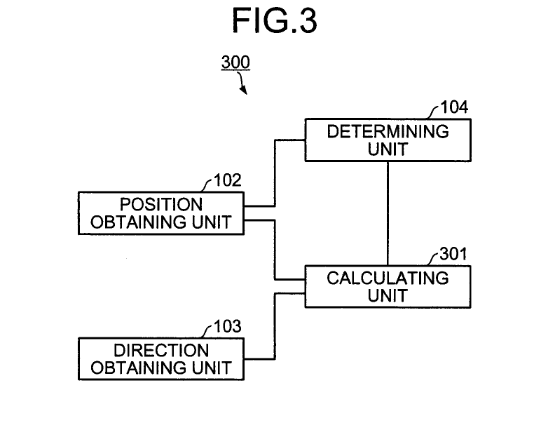

A functional configuration of a position calculation device 300 according to a second embodiment is described first. FIG. 3 is a block diagram of a functional configuration of the position calculation device according to the second embodiment.

As depicted in FIG. 3, the position calculation device 300 includes the position obtaining unit 102, the direction obtaining unit 103, the determining unit 104, and a calculating unit 301. The position obtaining unit 102, the direction obtaining unit 103, and the determining unit 104 are similar to those in the first embodiment, and thus the description thereof is omitted.

The calculating unit 301 calculates the current position and the traveling direction of the mobile object based on the current position data and the traveling direction data of the mobile object obtained by the position obtaining unit 102 and the direction obtaining unit 103, respectively. The calculating unit 301 calculates only the traveling direction of the mobile object without calculating the current position thereof, from the determination by the determining unit 104 that the mobile object has entered the parking lot until the determination that the mobile object has exited the parking lot.

### (Procedure of Position Calculation Process Performed by Position Calculation Device)

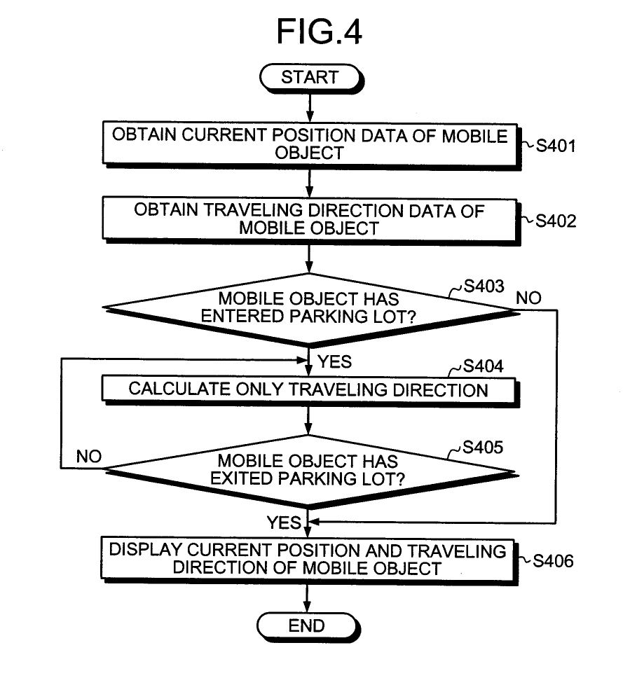

A procedure of position calculation process performed by the position calculation device 300 is described next. FIG. 4 is a flowchart of the procedure of position calculation process performed by the position calculation device. As depicted in the flowchart of FIG. 4, the current position data of the mobile object are obtained by the position obtaining unit 102 (step S401). The traveling direction data of the mobile object are obtained by the direction obtaining unit 103 (step S402). Similar to the flowchart of FIG. 2, steps S401 and S402 are continuously executed during execution of steps S403 to S406 described later.

Whether the mobile object has entered a parking lot is determined by the determining unit 104 based on the current position data of the mobile object obtained at step S401 (step S403). When it is determined at step S403 that the mobile object has entered the parking lot (step S403: YES), only the traveling direction of the mobile object is calculated by the calculating unit 301 without changing the current position thereof (step S404).

Whether the mobile object has exited the parking lot is determined by the determining unit 104 based on the current position data of the mobile object obtained at step S401 (step S405). When it is not determined at step S405 that the mobile object has exited the parking lot (step S405: NO), the process returns to step S404 and subsequent steps are executed repeatedly.

When it is determined at step S405 that the mobile object has exited the parking lot (step S405: YES), the current position and the traveling direction of the mobile object are calculated by the calculating unit 301 based on the current position data and the traveling direction data of the mobile object obtained at steps S401 and S402, respectively (step S406), thereby ending the sequence of processes.

On the other hand, when it is not determined at step S403 that the mobile object has entered the parking lot (step S403: NO), the process proceeds to step S406 and the current position and the traveling direction of the mobile object are calculated by the calculating unit 301 based on the current position data and the traveling direction data of the mobile object obtained at steps S401 and S402, respectively, thereby ending the sequence of processes.

As described above, the position calculation device 300 according to the second embodiment can calculate, by the calculating unit 301 that calculates the current position and the traveling direction of the mobile object, only the traveling direction of the mobile object without calculating the current position thereof, from the determination that the mobile object has entered the parking lot until the determination that the mobile object has exited the parking lot. Thus, even when an accurate position and/or direction cannot be obtained due to weak signals from GPS satellites, the error in the current position of the mobile object is limited to the size of the parking lot, thereby reducing the error in the current position of the mobile object.

### EXAMPLE

An example of the present invention will be described. In the example, the data display device and the position calculation device of the present invention are implemented by a navigation device mounted on a mobile object such as a vehicle (including four-wheel vehicles and two-wheel vehicles), for example.

### (Hardware Configuration of Navigation Device)

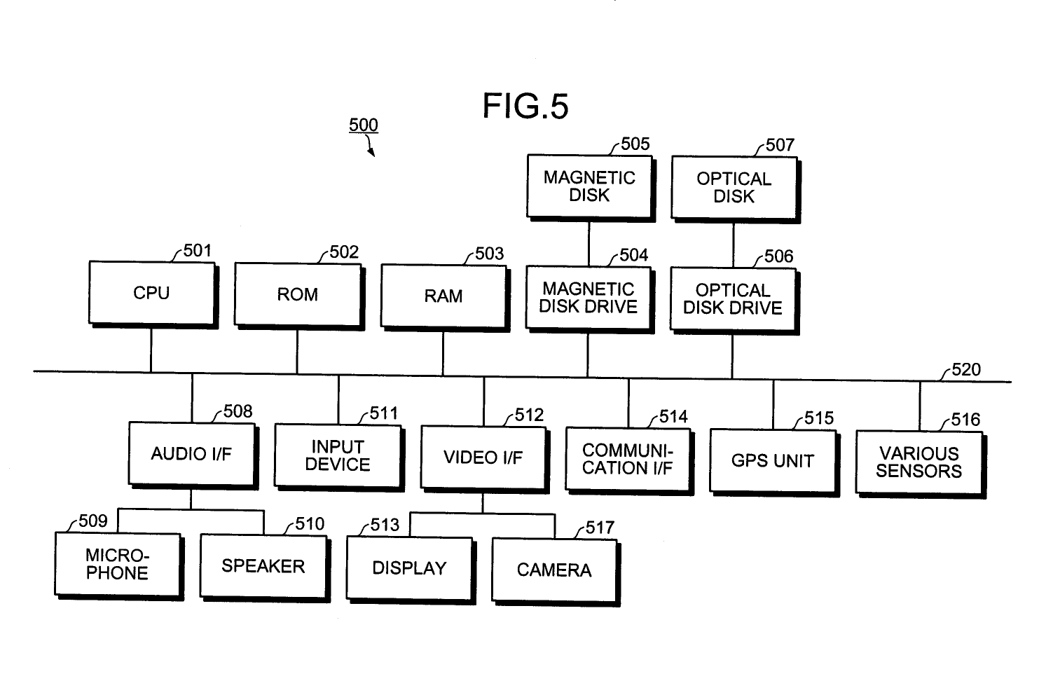

A hardware configuration of a navigation device 500 according to the example will be described. FIG. 5 is a block diagram of a hardware configuration of the navigation device according to the example. As depicted in FIG. 5, the navigation device 500 includes a CPU 501, a ROM 502, a RAM 503, a magnetic disk drive 504, a magnetic disk 505, an optical disk drive 506, an optical disk 507, an audio I/F (interface) 508, a microphone 509, a speaker 510, an input device 511, a video I/F 512, a display 513, a communication I/F 514, a GPS unit 515, various sensors 516, and a camera 517, respectively connected through a bus 520.

The CPU 501 governs overall control of the navigation device 500. The ROM 502 stores therein programs such as a boot program, a data update program, an entry/exit determination program, a type determination program, a position/direction calculation program, and a map matching program. The RAM 503 is used as a work area of the CPU 501. The CPU 501 executes various programs stored on the ROM 502 to generally control the navigation device 500, using the RAM 503 as a work area.

The entry/exit determination program determines whether the vehicle is positioned in a parking lot based on the result of map matching process and the reception intensity of signals from GPS satellites received by the GPS unit 515 (hereinafter, “GPS signal level”) described later. The entry/exit determination program may determine the vehicle has exited a parking lot when, for example, the traveling direction of the vehicle is substantially constant and the displacement of the vehicle reaches a given value. Alternatively, the entry/exit determination program may determine the vehicle has exited a parking lot when the speed of the vehicle reaches a given value (for example, 35 km/h or more), or when the altitude of the vehicle returns to the altitude when the vehicle was determined to enter the parking lot (the altitude is stored in the magnetic disk 505, the optical disk 507, etc.).

The type determination program determines the type of the parking lot where the vehicle has entered based on the GPS signal level received by the GPS unit 515 and changes in the evaluation of each GPS satellite and in the number of available GPS satellites. The type of the parking lot includes an indoor parking lot, a roof parking lot, an outdoor parking lot, a roadside parking lot, etc. For example, the type determination program determines whether the parking lot where the vehicle has entered is an indoor parking lot or other parking lot. The type determination program may determine whether the parking lot is an indoor parking lot, a roof parking lot, or other parking lot when the navigation device 500 performs hybrid measurement in which the current portion of the vehicle is calculated based on the output data from the GPS unit 515 and the output values from the various sensors 516 described later.

The position/direction calculation program calculates the current position and the direction of the vehicle based on the outputs from the GPS unit 515 and the various sensors 516. Based on the result of determination by the entry/exit determination program, the position/direction calculation program calculates only the traveling direction of the vehicle without calculating the current position thereof, from the determination by the determining unit 104 that the vehicle has entered the parking lot until the determination that the vehicle has exited the parking lot.

The map matching program identifies, based on the current position of the vehicle calculated by the position/direction calculation program and the map data, a position on a road where the vehicle is likely to be actually positioned, and displays a mark representing the current position of the vehicle at the position on the map. The map matching program may identify the position based on the traveling direction of the vehicle in addition to the current position and the map data. This state is referred to as on-road state.

When the current position of the vehicle calculated by the position/direction calculation program is away from any road by a given distance and thus a road where the vehicle is likely to be actually positioned is not identified, the map matching program determines the vehicle is not positioned on any road and displays the mark representing the current position of the vehicle at the position on the map corresponding to the current position of the vehicle calculated by the position/direction calculation program. This state is referred to as off-road state.

The map matching program displays a mark representing the direction of the vehicle based on the direction of the vehicle calculated by the position/direction calculation program. A single mark may represent both the current position and the direction of the vehicle.

The magnetic disk drive 504 controls the reading/writing of data with respect to the magnetic disk 505 under the control of the CPU 501. The magnetic disk 505 records the data written under the control of the magnetic disk drive 504. The magnetic disk 505 may be HD (hard disk) or FD (flexible disk), for example.

The optical disk drive 506 controls the reading/writing of data with respect to the optical disk 507 under the control of the CPU 501. The optical disk 507 is a removable recording medium having data read out under the control of the optical disk drive 506. A writable recording medium may be utilized for the optical disk 507. The removable recording medium may be a medium other than the optical disk 507, such as an MO and a memory card.

Exemplary information recorded on the magnetic disk 505 and optical disk 507 includes map data and function data. The map information includes background data representing features such as buildings, rivers, and ground surfaces, and road shape data indicative of road shapes, and is made up of data files sorted by districts.

The road shape data also include traffic condition data. The traffic condition data include, for example, information indicative of the presence of traffic lights, crosswalks, and presence of entrances/exits and junctions of expressways for the nodes, and lengths (distances) of links, road widths, directions of travel, road types (such as expressway, toll road, general road), etc., for the links.

The function data are three-dimensional data indicative of shapes of facilities on the map, text data indicative of explanations of the facilities, and various data other than the map data. The map data and the function data are recorded in a state of blocks sorted by district or function. Specifically, for example, the map data are recorded in blocks sortable by district such that respective blocks represent predetermined districts on the map displayed on a display screen. For example, the function data are recorded in multiple blocks sortable by function such that each block implements one function.

The function data are data for implementing functions of program data that implement route search, calculation of time required, route guide, etc., in addition to the three-dimensional data and the text data described above. The map data and the function data are sorted into data files according to district and function, respectively.

The audio I/F 508 is connected to the microphone 509 for audio input and the speaker 510 for audio output. Sounds received by the microphone 509 are A/D-converted within the audio I/F 508. The microphone 509 is disposed near a sun visor of the vehicle and one or more of the microphones 509 may be disposed. The speaker 510 outputs sounds of predetermined audio signals subjected to D/A conversion in the audio I/F 508. The sounds input from the microphone 509 may be recorded as audio data on the magnetic disk 505 or the optical disk 507.

The input device 511 includes a remote controller having keys for entering characters, numeric values, and various instructions; a keyboard; a touch panel; etc. The input device 511 may be implemented in single form such as a remote controller, a keyboard, and a touch panel, or may be implemented in multiple forms.

The video I/F 512 is connected to the display 513. Specifically, the video I/F 512 is made up of, for example, a graphic controller that generally controls the display 513, a buffer memory such as VRAM (Video RAM) that temporarily records immediately displayable image information, and a control IC that controls the display 513 based on image data output from a graphic controller.

The display 513 displays icons, cursors, menus, windows, or various data such as characters and images. The display 513 draws the above map data two-dimensionally or three-dimensionally. The map data displayed on the display 513 can be superimposed with a mark, etc., representative of the current position of the vehicle equipped with the navigation device 500. The current position of the vehicle is calculated by the CPU 501.

For example, a CRT, a TFT liquid crystal display, a plasma display, etc., may be employed as the display 513. The display 513 is disposed near the dashboard of the vehicle. The display 512 may be disposed in plural in the vehicle in such a way that the displays are disposed in the vicinity of the backseat of the vehicle as well as near the dashboard of the vehicle.

The communication I/F 514 is wirelessly connected to a network and functions as an interface between the navigation device 500 and the CPU 501. The communication I/F 514 is wirelessly connected to a communication network such as the Internet and also functions as an interface between this communication network and the CPU 501.

The communication network includes LAN, WAN, public line network, portable telephone network, etc. Specifically, the communication I/F 514 is made up of, for example, an FM tuner, VICS (Vehicle Information and Communication System)/beacon receiver, a radio navigation device, and other navigation devices and acquires road traffic information, such as road congestion and traffic regulations, distributed from VICS centers. VICS is a registered trademark. The communication I/F 514 is made up of an in-vehicle radio device for bidirectional communication with a roadside radio device when, for example, a dedicated short range communication (DSRC) is employed, and obtains various data such as traffic information and map data. A specific example of DSRC is ETC (non-stop automatic toll correction system).

The GPS unit 515 receives signals from GPS satellites and outputs information indicative of the current position of the vehicle. The information output from the GPS unit 515 is used together with values output from the various sensors 516 (described hereinafter) when the CPU 501 calculates the current position of the vehicle. The information indicative of the current position is information specifying one point on map information, for example, altitude/longitude and altitude.

GPS is an abbreviation of the global positioning system, and identifies an accurate position on the earth by receiving GPS signals from 4 or more satellites. The GPS unit 515 is made up of an antenna that receives GPS wave from GPS satellites, a tuner that demodulates the received GPS wave, and an operational circuit that calculates the current position based on the demodulated data, etc.

The various sensors 516 are those outputting information for determining the position and behavior of the vehicle, such as a vehicular speed sensor, an acceleration sensor, and an angular-speed sensor. The values output from the various sensors 516 are used by the CPU 501 for calculating the current position of the vehicle and calculating changes in velocity and direction. The various sensors 516 may include a direction sensor that detects change in traveling direction of the vehicle.

The camera 517 captures images inside or outside the vehicle. The images may be still images or moving images and, for example, the camera 517 captures images of behaviors of a passenger inside the vehicle and outputs the captured images to a recording medium such as the magnetic disk 505 and the optical disk 507 through the video I/F 512. The camera 517 captures images of conditions outside the vehicle and outputs the captured images to the recording medium such as the magnetic disk 505 and the optical disk 507 through the video I/F 512. The camera 517 has an infrared camera function, and distributions of surface temperatures of objects present inside the vehicle may relatively be compared based on the image information captured with the use of the infrared camera function. The images output to the recording medium are overwritten and saved.

Functions of the display unit 101, the position obtaining unit 102, the direction obtaining unit 103, the determining unit 104, and the display control unit 105 included in the data display device 100 depicted in FIG. 1, and functions of the position obtaining unit 102, the direction obtaining unit 103, the determining unit 104, and the calculating unit 301 included in the position calculation device 300 depicted in FIG. 3 are implemented by the CPU 501 executing a given program and controlling each unit of the navigation device 500 using programs/data recorded in the ROM 502, the RAM 503, the magnetic disk 505, and the optical disk 507, etc., of the navigation device 500 depicted in FIG. 5.

In other words, the navigation device 500 according to the example can execute the functions of the data display device and the position calculation device depicted in FIGS. 1 and 3 according to the procedure of display control process and the procedure of position calculation process depicted in FIGS. 2 and 4 by executing the display control program and the position calculation program recorded in the ROM 502 as a recording medium of the navigation device 500, respectively.

### (Contents of Process Performed by Navigation Device)

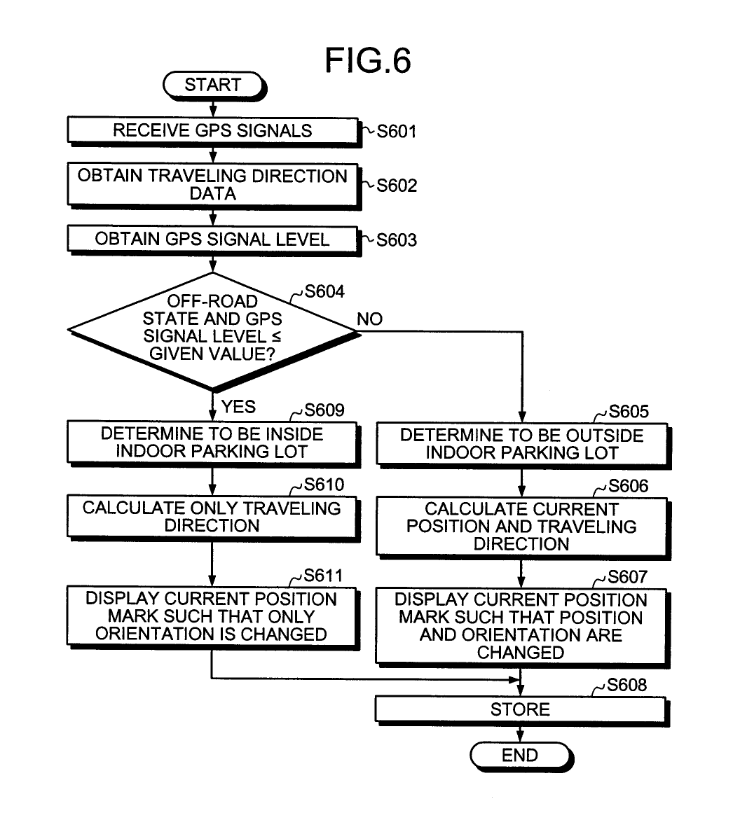

Contents of a process performed by the navigation device 500 are described next. This process is repeated at a given interval. FIG. 6 is a flowchart indicating the contents of the process performed by the navigation device. As depicted in the flowchart of FIG. 6, GPS signals are received by the GPS unit 515 (step S601). The traveling direction data of the vehicle are obtained by the various sensors 516 (step S602).

The GPS signal level of GPS signals received at step S601 is obtained (step S603), and it is determined whether the previous execution of the map matching process indicated an off-road state and the GPS signal level obtained at step S603 is equal to or smaller than a given value (step S604). The result of map matching process will be described later. In determining whether the GPS signal level is equal to or smaller than the given value at step S604, for example, the highest signal level among GPS signals received by the GPS unit 515 is obtained. Alternatively, an average of the levels of the GPS signals, or an average of the levels of GPS signals from GPS satellites that satisfy a specific condition such as the elevation and the direction of each GPS satellite, the number of available GPS satellites, etc., may be obtained. A value obtained by applying a Kalman filter to the GPS signal level for removal of noise may be used. The GPS signal level is determined to be 0 when the GPS unit 515 does not receive any GPS signal.

When it is determined at step S604 that the previous execution of the map matching indicated an on-road state or the GPS signal level exceeds the given value (step S604: NO), the current position of the vehicle is determined to be outside the indoor parking lot (step S605). The current position and the traveling direction of the vehicle are calculated based on the GPS signals and the traveling direction data obtained at steps S601 and S602, respectively (step S606).

A map matching process is performed based on the current position and the traveling direction calculated at step S606 and the map data, and a current position mark of the vehicle is displayed on the map such that the position and the orientation thereof are changed (step S607). Whether the matching process at step S607 indicates an on-road state or an off-road state is stored into a memory (not shown) (step S608), thereby ending the sequence of processes.

On the other hand, when it is determined at step S604 that the previous execution of the map matching process indicates an off-road state and the GPS signal level is equal to or smaller than the given value (step S604: YES), the current position of the vehicle is determined to be inside the indoor parking lot (step S609), and only the traveling direction of the vehicle is calculated based on the traveling direction data obtained at step S602 (step S610). Based on the traveling direction calculated at step S610, the mark representing the current position of the vehicle (hereinafter, “current position mark”) is displayed on the map such that only the orientation of the current position mark is changed (step S611), and the process proceeds to step S608. In this case, off-road state is stored into the memory at step S608, thereby ending the sequence of processes.

In the flowchart of FIG. 6, when the navigation device 500 performs hybrid measurement, for example, it may be also determined at step S604 whether the GPS signal is equal to or smaller than a threshold indicating roof parking lot. In this case, when the GPS signal level is equal to or smaller than the given value or the threshold indicating roof parking lot, the process proceeds to step S609 and the current position of the vehicle is determined to be inside the indoor parking lot or the roof parking lot, and subsequent steps are executed. When the GPS signal level exceeds the given value or the threshold indicating roof parking lot, the process proceeds to step S605 and the current position of the vehicle is determined to be outside the indoor parking lot or the roof parking lot, and subsequent steps are executed.

### (Difference in Display of Current Position Mark of Vehicle Between Conventional Example and Present Example)

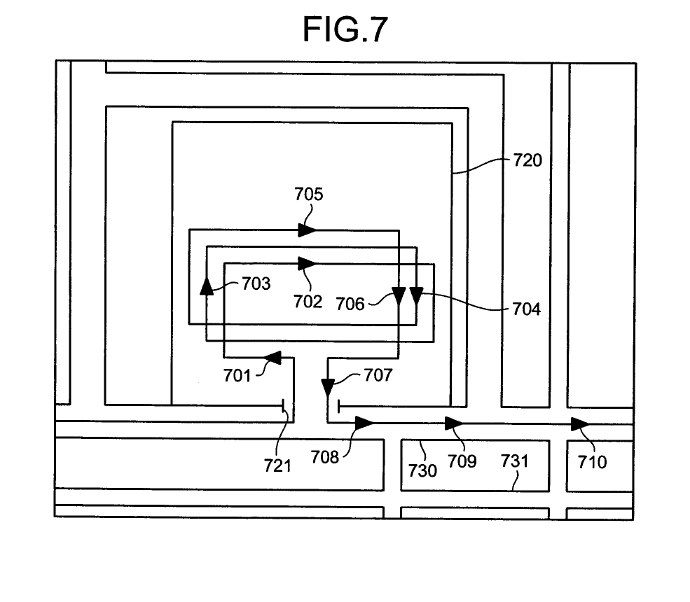

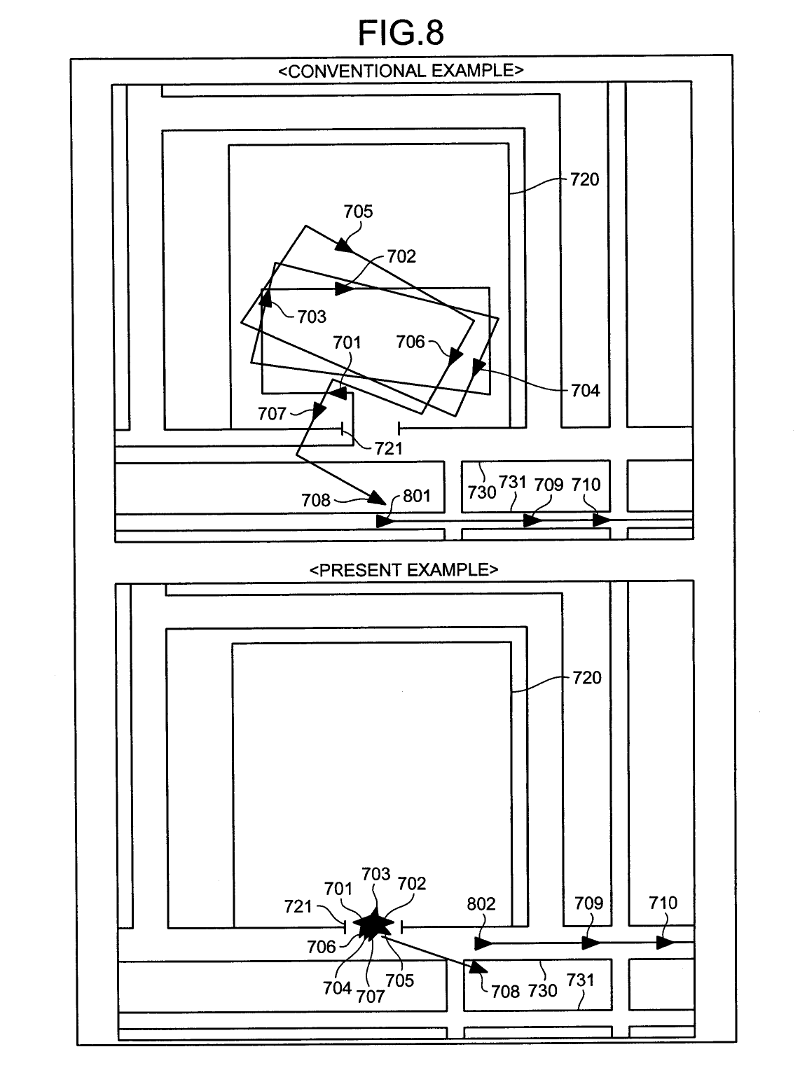

With reference to FIGS. 7 and 8, the process at step S611 of FIG. 6 in which only the direction of the current position mark is changed is described next. FIG. 7 is a diagram of an actual trace of the vehicle. FIG. 8 is a diagram for explaining the difference in display of the current position mark of the vehicle between the conventional example and the present example.

For example, as depicted in FIG. 7, it is assumed that the vehicle enters an indoor parking lot 720 from an entrance/exit 721 thereof, travels within the indoor parking lot 720 following a path from current position marks 701 to 707, exits from the entrance/exit 721, and travels following a path from current position marks 708 to 710.

As depicted in FIG. 8, in the conventional display of the current position mark, the position and the orientation of the current position mark are both changed even in the indoor parking lot 720 where the GPS signal level, for example, is equal to or smaller than the given value and thus the current position data of the vehicle are obtained by the velocity sensor and/or the acceleration sensor included in the various sensors 516. Thus, an accurate position of the vehicle cannot be obtained, thereby causing an error. In the indoor parking lot 720, for example, when the parking spaces are divided into several floors, the vehicle circles when going up and down a slope that passes through the floors. Thus, the effect of the gravity due to the slope causes the displacement of the vehicle detected for calculation of the current position to be greater than the actual displacement, thereby further causing an error.

Due to the error described above, for example, the current position mark 707 upon exit from the indoor parking lot 720 is displayed in FIG. 8 at different position and direction from where the vehicle actually exit the indoor parking lot 720 (the current position mark 707 of FIG. 7). When the vehicle proceeds to the current position mark 708 after the exit from the indoor parking lot 720, nonetheless the vehicle is actually positioned on a road 730 near the parking lot 720 as depicted in FIG. 7, the current position mark 708 is displayed near a different road 731 in the conventional example of FIG. 8. When map matching process is performed on this current position mark 708, for example, a current position mark 801 after the map matching is displayed on the road 731 where the vehicle is not actually positioned.

On the other hand, in the display of the current position mark according to the present example, only the orientation of the current position mark is changed without changing the position thereof when it is determined the vehicle has entered the indoor parking lot 720. Thus, an error in the position is limited to the size of the indoor parking lot 720 even if an error in the direction occurs. Thus, the current position mark 707 upon the exit from the indoor parking lot 720 is displayed nearer than the conventional example where the vehicle actually exit the indoor parking lot 720 (the current position mark 707 of FIG. 7). Thus, when the vehicle proceeds to the current position mark 708 after the exit from the indoor parking lot 720, the current position mark 708 is displayed near the road 730 where the vehicle is actually positioned as depicted in FIG. 7. When map matching process is performed on this current position mark 708, for example, a current position mark 802 after the map matching is displayed on the road 730 where the vehicle is actually positioned.

As described above, the current position mark of the vehicle is displayed at a position much away from the actual position in the conventional display of the current position mark. Thus, in the map matching process, the vehicle is erroneously positioned on a road different from where the vehicle is actually positioned after the exit from the indoor parking lot. On the other hand, in the display of the current position mark according to the present example, the current position mark of the vehicle is displayed at a position near the actual position since the error in the position of the vehicle is limited to the size of the parking lot. Thus, in the map matching process, the vehicle can be positioned on a road where the vehicle is actually positioned after the exit from the indoor parking lot. As described above, the display of the current position mark according to the present example can reduce the error in the map matching.

As described above, the navigation device 500 according to the example can calculate, by the calculating unit 301 that calculates the current position and the traveling direction of the mobile object, only the traveling direction of the mobile object without calculating the current position thereof, from the determination that the mobile object has entered the parking lot until the determination that the mobile object has exited the parking lot. Thus, even when an accurate position and/or direction cannot be obtained due to weak signals from GPS satellites, the error in the current position of the mobile object is limited to the size of the parking lot, thereby reducing the error in the current position of the mobile object.

The navigation device 500 according to the example can cause the display unit 101 to display, by the display control unit 105 that causes the display unit 101 to display the current position and the traveling direction of the mobile object, the mobile object such that the current position of the mobile object is not changed and only the traveling direction thereof is changed, from the determination that the mobile object has entered the parking lot until the determination that the mobile object has exited the parking lot. Thus, even when an accurate position and/or direction cannot be obtained due to weak signals from GPS satellites, the error in the current position of the mobile object is limited to the size of the parking lot, thereby reducing the error in the current position of the mobile object.

The navigation device 500 according to the example can cause the display unit 101 to display, by the display control unit 105, the mobile object such that the current position of the mobile object is not changed and only the traveling direction thereof is changed, from the determination that the mobile object has entered the indoor parking lot until the determination that the mobile object has exited the indoor parking lot. Thus, the position and the direction are changed for a roof parking lot where signals from GPS satellites are strong, while only the direction is changed for an indoor parking lot where signals from GPS satellites are weak. Thus, the position and the direction are changed even when the mobile object is positioned in a parking lot as long as an accurate position and/or direction are obtained, thereby further reducing the error in the current position of the mobile object.

The navigation device 500 according to the example causes, by the display control unit 105, the display unit 101 to display on a map a mark disposed on the current position of the mobile object and oriented to the traveling direction of the mobile object. The data display device 100 can cause, by the display control unit 105, a display means to display the mark on the map such that the position of the mark is not changed and only the orientation thereof is changed, from the determination that the mobile object has entered the parking lot until the determination that the mobile object has exited the parking lot. Thus, even when an accurate position and/or direction cannot be obtained due to weak signals from GPS satellites, the error in the position of the mark is limited to the size of the parking lot, thereby reducing an error in map matching after the exit from the parking lot.

The display control method and the position calculation method described in the first and the second embodiments, respectively, may be implemented by executing a preliminarily prepared program, the program being executed by a computer such as a personal computer, a workstation, and a mobile terminal (mobile phone). The program is recorded on a computer-readable recording medium such as a hard disk, a flexible disk, a CD-ROM, an MO, and a DVD and is read from the recording medium by the computer for execution. The program may be a transmission medium distributable through a network such as the Internet.

1-9. (canceled)

10. A data display device comprising:
a position obtaining unit that obtains current position data of a mobile object;
a direction obtaining unit that obtains traveling direction data of the mobile object;
a display control unit that causes a display unit to display a current position and a traveling direction of the mobile object based on the current position data and the traveling direction data of the mobile object; and
a determining unit that determines that the mobile object has entered or exited a parking lot based on the current position data of the mobile object, wherein
the display control unit causes the display unit to display the mobile object such that the current position of the mobile object is not changed and only the traveling direction of the mobile object is changed, from a determination that the mobile object has entered the parking lot until a determination that the mobile object has exited the parking lot.

11. The data display device according to claim 10, wherein
the determining unit further determines a type of the parking lot upon entry of the mobile object into the parking lot, and
the display control unit causes the display unit to display the mobile object such that the current position of the mobile object is not changed and only the traveling direction of the mobile object is changed, from a determination that the mobile object has entered an indoor parking lot until a determination that the mobile object has exited the indoor parking lot.

12. The data display device according to claim 10, wherein the display control unit
causes the display unit to display on a map a mark disposed on the current position of the mobile object and oriented to the traveling direction of the mobile object, and
causes the display unit to display the mark on the map such that the position of the mark is not changed and only orientation of the mark is changed, from the determination that the mobile object has entered the parking lot until the determination that the mobile object has exited the parking lot.

13. A position calculation device comprising:
a position obtaining unit that obtains current position data of a mobile object;
a direction obtaining unit that obtains traveling direction data of the mobile object;
a calculating unit that calculates a current position and a traveling direction of the mobile object based on the current position data and the traveling direction data of the mobile object; and
a determining unit that determines that the mobile object has entered or exited a parking lot based on the current position data of the mobile object, wherein
the calculating unit calculates only the traveling direction of the mobile object without calculating the current position of the mobile object, from a determination that the mobile object has entered the parking lot until a determination that the mobile object has exited the parking lot.

14. A display control method for a data display device that includes a position obtaining unit and a direction obtaining unit that obtain current position data and traveling direction data of a mobile object, respectively, and displays a current position and a traveling direction of the mobile object based on the current position data and the traveling direction data of the mobile object, the display control method comprising:
determining that the mobile object has entered or exited a parking lot based on the current position data of the mobile object; and
causing the data display device to display the mobile object such that the current position of the mobile object is not changed and only the traveling direction of the mobile object is changed, from a determination that the mobile object has entered the parking lot until a determination that the mobile object has exited the parking lot.

15. A position calculation method for a position calculation device that includes a position obtaining unit and a direction obtaining unit that obtain current position data and traveling direction data of a mobile object, respectively, and calculates a current position and a traveling direction of the mobile object based on the current position data and the traveling direction data of the mobile object, the position calculation method comprising:
determining that the mobile object has entered or exited a parking lot based on the current position data of the mobile object; and
calculating only the traveling direction of the mobile object without calculating the current position of the mobile object, from a determination that the mobile object has entered the parking lot until a determination that the mobile object has exited the parking lot.

16. A computer-readable recording medium that stores therein a display control program that causes a computer to execute the display control method according to claim 14.

17. A computer-readable recording medium that stores therein a position calculation program that causes a computer to execute the position calculation method according to claim 15.
